(19) United States
(12) Patent Application Publication
(10) Pub. No.: US 2008/0027674 A1
(43) Pub. Date: Jan. 31, 2008

(54) FLASHLIGHT/PEDOMETER

(76) Inventors: Bonni Shevin Sandy, Morton Grove, IL (US); Xiao Gang, Guangdong (CN)

Correspondence Address: PERKINS COIE LLP, POST OFFICE BOX 1208, SEATTLE, WA, 98111-1208, US

(21) Appl. No.: 11/561,279

(22) Filed: Nov. 17, 2006

(51) Int. Cl. G01C 22/00

(52) U.S. Cl. 702/160

(57) ABSTRACT

A flashlight/pedometer has a pedometer assembly in a body. The pedometer assembly detects and counts paces or steps. The number of steps is displayed on a display on the body. A head is pivotally attached to the body via a hinge connection. The head includes one or more lighting elements controlled by a switch. The flashlight/pedometer performs both pedometer and flashlight functions.

### BACKGROUND OF THE INVENTION

Walking is increasingly a common and popular form of exercise. Various types of pedometers have been used by walkers to measure the distance walked. Generally, pedometers operate by detecting a walker's movement. Each shift in the walker's body position, which occurs with each step taken, is detected and counted by the pedometer. By counting steps or paces taken, a walker can then determine distance walked. Alternatively, paces counted on any given walk segment, day, or path, can be used for comparison purposes, instead of for determining an absolute distance covered.

Walking at night or in dark places can present certain hazards. Perhaps the greatest hazard arises from motor vehicles, since walkers must often share or cross roadways used by motor vehicles. Since visibility is limited under dim or dark conditions, the risk of a walker being hit by a motor vehicle is significant, especially if the walker is wearing dark clothing. Rainy and foggy conditions can further heighten this risk.

For improved visibility, some clothing and shoes have been made with reflective surfaces. In addition, some walkers may prefer to carry a flashlight, for improved visibility to motorists, as well as to better illuminate and avoid obstacles or hazards in the walker's path. However, carrying a flashlight while walking may be inconvenient. Moreover, a walker desiring to walk in dim or dark lighting conditions, while also counting paces walked or distance covered, must carry both a pedometer and a flashlight (or other lighting device) with both devices requiring charged batteries. Accordingly, an improved device is needed to provide a pedometer function, as well as a lighting function.

### SUMMARY OF THE INVENTION

A new combination flashlight/pedometer has now been invented providing both pedometer (step counting) and lighting functions. As a result, both functions are combined into an efficient, compact, and highly useful pedometer/flashlight device. Since both the pedometer function and the lighting function may operate from the same battery source, duplicate battery sources are avoided. Other objects and advantages will appear in the following detailed description, wherein a single embodiment is disclosed and described. It should be understood, however, that the following detailed description and drawings are designed for the purpose of illustration and description only, and are not intended as a definition of the limits of the invention.

### BRIEF DESCRIPTION OF THE DRAWINGS

In the drawings, wherein the same element number indicates the same element in each of the views:

FIG. 1 is a top and front perspective view of a novel flashlight/pedometer according to an embodiment of the invention.

FIG. 2 is a bottom view of the flashlight/pedometer shown in FIG. 1.

FIG. 3 is a left side view of the flashlight/pedometer shown in FIGS. 1 and 2.

FIG. 4 is a top view.

FIG. 5 is a back end view.

FIG. 6 is a right side view.

FIG. 7 is a right side view, similar to FIG. 6, and showing the head of the pedometer pivoted at an angle to the body of the pedometer.

### DETAILED DESCRIPTION OF THE PREFERRED EMBODIMENT

In general terms, the present flashlight/pedometer has a first section or piece which may typically include a pedometer assembly, a display, and/or batteries. A second section or piece is advantageously pivotably attached to the first section. The second section includes one or more lighting elements, controlled by a switch. The switch may be on either the first or second section. A clip is advantageously provided on the first section, to allow the first section to be attached to the users belt, waistband, etc. The second section, including the lighting element(s) can then be pivoted to direct a light beam as desired.

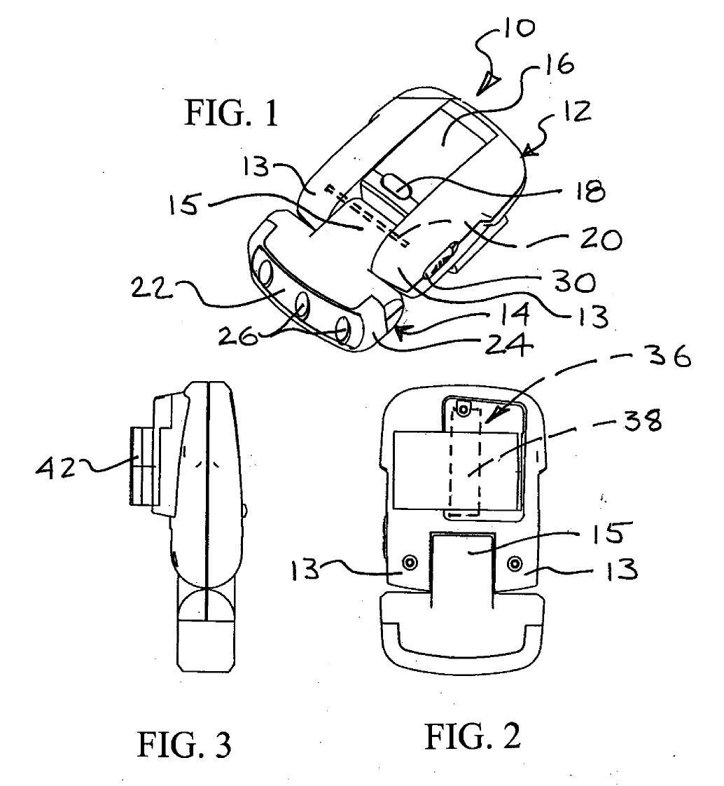

Turning now in detail to the drawings, as shown in FIG. 1, a flashlight/pedometer 10 has a first section or body 12 attached to a second section or head 14 by a hinge or pivot connection 20. A display, such as an LCD display 16, is provided on the body 12 or head 14. In the design shown, the display 16 is on the body 12. A reset button 18 is used for resetting the count of steps or paces taken. The reset button 18 is typically provided adjacent to the display 16, although it may optionally be located at other positions on the body 12 or head 14.

As best shown in FIG. 1, one or more lighting elements 26, such as LEDs, are provided on the head 14. In the design shown, three LEDs 26 are used. A reflector 22 may optionally be provided around or behind the LEDs 26. A transparent lens or cover 24 may also optionally be attached over the LEDs 26 on the head 14. The cover 24 may act as a physical barrier to better prevent damage or degradation of the LEDs 26. Alternatively, the cover 24 may also act as a lens, to focus light emitted by the LEDs 26.

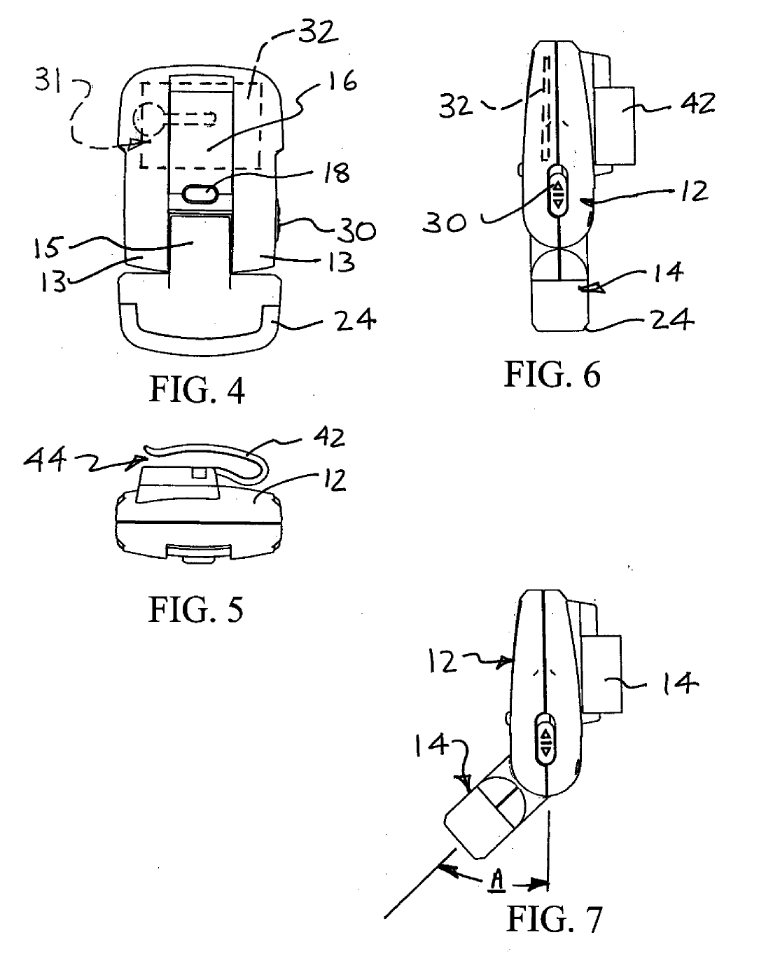

Referring now also to FIGS. 2, 4, and 6, a pedometer assembly 31 is provided within the body 12. The pedometer assembly 31 typically includes a circuit 32 and a pendulum, accelerometer, or other device 33 to detect the users steps. The circuit 32 counts steps detected by the device 33, and displays the number of steps on the display 16. The circuit 32 is electrically connected to the display 16, the reset button 18, the device 33, and to batteries 38. The circuit 32, device 33, and batteries 38 are typically contained within the body 12 of the flashlight/pedometer 10. However, one or more of these elements may optionally be located on or in the head 14.

A lighting switch 30 is also electrically connected to the batteries 38 and to the LEDs 26, for switching the LEDs on and off. Although the switch 30 is shown in FIGS. 1 and 6 as located on the side of the body 12, the switch 30 may be located elsewhere as well, including on the head 14. One or more batteries may be used. In the design shown, four 1.5 volt DC (AG12) batteries are contained within the body 12.

As shown in FIG. 5, a clip 42 is attached to the body 12. The opening 44 of the clip 42 is on the left side in FIG. 5. As shown in FIG. 1, the head 14 may have a narrower rearwardly projecting neck section 15, with the head 14 generally having a T shape. The neck section 15 extends between a pair of arms 13 on the body. The pivotable connection or hinge 20 may be made between the arms 13 and the neck section 15 of the head 14.

In use, the flashlight/pedometer 10 is clipped onto a users belt, waistband, etc. via the clip 42. The opening 44 of the clip 42 is oriented with the pendulum, accelerometer, or other device 33, so that as the user walks, the device 33 detects walking movement. The circuit 32 counts paces which are displayed on the display 16. The LEDs 26 may be turned on via the switch 30. Referring to FIGS. 1 and 7, the head 14 can pivot through ± angle A. Angle A may advantageously range 5-120, 15-90 or 30-50 degrees. In the design shown, angle A is about 30-45 degrees. This allows the light from the LEDs 26 to be aimed within a wide angle, without the need for moving the body 12 which is attached to the user. In addition to making the user more visible, light from the LEDs 26 may be aimed as needed on the pathway ahead of the user. The light may also be aimed onto a lock (such as a car door, entry door, etc.) as may be needed or desired. The circuit 32 may optionally be provided with a beacon/blink function, to optionally cause the LEDs 26 to flash or blink, to enhance the visibility of the user, and also conserving battery power.

Thus a novel flashlight/pedometer has been shown and described. Various changes and substitutions may of course be made, without departing from the spirit and scope of the invention. The invention, therefore, should not be limited, except to the following claims, and the equivalents.

1. A flashlight/pedometer comprising:
a body;
a pedometer assembly in the body linked to a display on the body;
a head pivotally attached to the body via a hinge connection; and
one or more lighting elements in the head.

2. The flashlight/pedometer of claim 1 further comprising a reflector in the head, and a lens on the head covering the lighting element

3. The flashlight/pedometer of claim 1 further comprising one or more batteries in the body and wire leads connecting the batteries in the body through the lighting switch on the body to the lighting element in the head.

4. The flashlight/pedometer of claim 1 with head pivotable up to ±90 degrees relative to the body.

5. The flashlight/pedometer of claim 1 with the body further comprising a pair of spaced apart arms, and with the head having a neck section positioned between the spaced apart arms.

6. The flashlight/pedometer of claim 1 further comprising a clip on the body.

7. The flashlight/pedometer of claim 1 with the body having a top surface and a bottom surface, and further comprising a clip on the body, with the clip having an opening adjacent to the bottom surface of the body.

8. The flashlight/pedometer of claim 7 further comprising one or more batteries in the body and wire leads connecting the batteries in the body through a lighting switch on the top surface of the body to the lighting element in the head.

9. A combination flashlight/pedometer comprising:
a first section;
a pedometer assembly in the first section including a circuit for detecting walking movement;
a display on the first section linked to the circuit;
one or more batteries in the first section linked to the circuit;
a clip on the first section;
a second section attached to the first section by a pivot joint;
one or more lighting elements in the second section; and
wire leads connecting the batteries in the first section through the lighting switch on the first section to the lighting element in the second section.

10. The flashlight/pedometer of claim 9 further comprising a reflector in the second section, and a cover on the second section covering the lighting element.

11. The flashlight/pedometer of claim 9 with the body having a top surface and a bottom surface, and further comprising a clip on the body, with the clip having an opening adjacent to the bottom surface of the body.

12. The flashlight/pedometer of claim 9 further comprising one or more batteries in the body and wire leads connecting the batteries in the body through a lighting switch on the top surface of the body to the lighting element in the head.

13. A flashlight and pedometer comprising:
a first section;
a pedometer assembly in the first section including a circuit for detecting and counting walking movement;
a display on the first section linked to the circuit;
one or more batteries in the first section linked to the circuit;
a clip on the first section;
a lighting switch on the first section;
a second section attached to the first section by a pivot joint;
one or more lighting elements in the second section;
a reflector in the second section associated with the lighting element;
a cover on the second section covering the lighting element;
wire leads connecting the batteries in the first section to the lighting switch and to the lighting element in the second section.
